(19) United States
(12) Patent Application Publication
(10) Pub. No.: US 2001/0025363 A1
(43) Pub. Date: Sep. 27, 2001

(54) Designer configurable multi-processor system

(76) Inventors: Cary Ussery, Hamilton, MA (US); Oz Levia, Sunnyvale, CA (US); John Gostomski, Rochester, NY (US); Gzim Derti, Victor, NY (US); Mark A. Indovina, Rochester, NY (US)

Correspondence Address: TESTA, HURWITZ & THIBEAULT, LLP, HIGH STREET TOWER, 125 HIGH STREET, BOSTON, MA, 02110, US

(21) Appl. No.: 09/757,373

(22) Filed: Jan. 9, 2001

Related U.S. Application Data
(60) Provisional application No. 60/191,998, filed on Mar. 24, 2000.

(51) Int. Cl. G06F 17/50

(52) U.S. Cl. 716/1

(57) ABSTRACT

A designer configurable processor for a single or multi-processing system is described. The processor includes a plurality of designer configurable computational units, such as Very Long Instruction Word (VLIW) processor task engine, that operate in parallel. A memory device communicates with the plurality of computational units through a data communication module. The memory device stores at least one of data and instruction code. A software development tool, which can include a compiler, an assembler, an instruction set simulator, or a debugging environment, configures the plurality of computational units. The software development tool configures various aspects of the processor architecture and various operating parameters of the processor and can generate a synthesizable RTL description of the processor and a single or multi-processing system.

### RELATED APPLICATIONS

This application claims priority to provisional patent application Ser. No. 60/191,998, filed on Mar. 24, 2000, the entire disclosure of which is incorporated herein by reference.

### FIELD OF THE INVENTION

The present invention relates to configurable electronic systems. In particular, the present invention relates to methods and apparatus for designer configurable multi-processor systems.

### BACKGROUND OF THE INVENTION

Custom integrated circuits are widely used in modern electronic equipment. The demand for custom integrated circuits is rapidly increasing because of the dramatic growth in the demand for highly specific consumer electronics and a trend towards increased product functionality. Also, the use of custom integrated circuits is advantageous because custom circuits reduce system complexity and, therefore, lower manufacturing costs, increase reliability and increase system performance.

There are numerous types of custom integrated circuits. One type consists of programmable logic devices (PLDs), including field programmable gate arrays (FPGAs). FPGAs are designed to be programmed by the end designer using special-purpose equipment. Programmable logic devices are, however, undesirable for many applications because they operate at relatively slow speeds, have a relatively low capacity, and have relatively high cost per chip.

Another type of custom integrated circuit are application-specific integrated circuits (ASICs), including gate-array based and cell-based ASICs, which are often referred to as “semicustom” ASICs. Semi-custom ASICs are programmed by either defining the placement and interconnection of a collection of predefined logic cells which are used to create a mask for manufacturing the IC (cell-based) or defining the final metal interconnection layers to lay over a predefined pattern of transistors on the silicon (gate-array-based). Semi-custom ASICs can achieve high performance and high integration, but can be undesirable because they have relatively high design costs, have relatively long design cycles (i.e., the time it takes to transform a defined functionality into a mask), and relatively low predictability of integrating into an overall electronic system.

Another type of custom integrated circuit is referred to as application-specific standard parts (ASSPs), which are non-programmable integrated circuits that are designed for specific applications. These devices are typically purchased off-the-shelf from integrated circuit suppliers. ASSPs have predetermined architectures and input and output interfaces. They are typically designed for specific products and, therefore, have short product lifetimes.

Yet another type of custom integrated circuit is referred to as a software-only architecture. This type of custom integrated circuit uses a general-purpose processor and a high-level language compiler. The designer programs the desired functions with a high-level language. The compiler generates the machine code that instructs the processor to perform the desired functions. Software-only designs typically use general-purpose hardware to perform the desired functions and, therefore, have relatively poor performance because the hardware is not optimized to perform the desired functions.

A relatively new type of custom integrated circuit uses a configurable processor architecture. Configurable processor architectures allow a designer to rapidly add custom logic to a circuit. Configurable processor circuits have relatively high performance and provide rapid time-to-market. There are two major types of prior art configurable processors circuits. One type of configurable processor circuit uses configurable Reduced Instruction-Set Computing (RISC) processor architectures. The other type of configurable processors circuit uses configurable Very Long Instruction Word (VLIW) processor architectures.

Configurable RISC processor circuits are commonly used today. These processor circuits provide the ability to introduce custom instructions into the RISC processor to accelerate a common operation. Custom logic for these operations can be added into the sequential data path of the processor. Configurable RISC processor circuits have a modest incremental improvement in performance relative to non-configurable RISC processors circuits.

The improved performance of configurable RISC processor circuits relative to ASIC circuits is achieved by converting operations that take multiple RISC instructions to execute and reducing them to a single operation. However, the incremental performance improvements achieved with configurable RISC processor circuits are far less than custom circuits that parallelize data flow by using a custom logic block.

Configurable VLIW processor architectures are currently being used in high-end Digital Signal Processing (DSP) circuits. Configurable VLIW processor architectures can achieve significant increases in performance by using parallel execution of operations. The performance improvements of VLIW processors are achieved by increasing the width of the instructions. VLIW processors require more complex compilers to compile the VLIW instructions and require a relatively large amount of memory for a particular application.

Prior art configurable VLIW processor architectures are difficult to design and difficult to support with high-level language compilers. The ability to add custom units in these prior art configurable VLIW processor architectures is limited to adding custom units in predefined locations in the data path. Configurability is typically achieved by custom, assembly language programming. Furthermore, these prior art configurable VLIW processor architectures are single processor architectures.

### SUMMARY OF THE INVENTION

The present invention relates to designer configurable multi-processor systems and designer configurable processors. The present invention also relates to methods of using a software program to create designer-defined custom processors and multi-processor hardware systems. Configurable processors and multi-processor systems of the present invention allow designers to rapidly configure custom hardware architectures of single or multi-processor systems. Such systems are useful for very high-performance applications like network processing, multi-channel speech processing and image/video processing that require a degree of programmability.

One advantage of the designer configurable multi-processor system of the present invention is that designers can define and integrate custom data path elements into a processor. Another advantage of the designer configurable multi-processor system of the present invention is that the designer can define and integrate custom computational units into a processor. These custom data paths and computational units can be tailored to very specific applications and can enable the designer to significantly improve the run time performance of the processor.

Accordingly, the present invention features a designer configurable processor that can be used in a multi-processing system. The processor includes a plurality of designer configurable computational units that operate in parallel. In one embodiment, the designer configurable computational units comprise Very Long Instruction Word (VLIW) processor task engines. The computational units can include a set of input registers and a set of result registers.

The designer configurable processor also includes one or more memory devices that communicate with the plurality of computational units through a data communication module. Each memory device stores data and/or instruction code. In one embodiment, the data communication module is a register routed data communication module.

In one embodiment, the designer configurable processor includes a task queue that communicates with a task queue control module. The task queue control module schedules tasks for the processor. The task queue can include up to three queue modules for standard, high priority, and interrupt task queue functionality. Multi-processing systems include a task queue that communicates via a common task queue bus for each of the multiple processors. The processor can also include an instruction memory that communicates with the task queue controller module. The instruction memory stores tasks for the processor.

The designer configurable processor also includes a software development tool that configures the plurality of computational units. The software development tools can include a compiler, an assembler, an instruction set simulator, or a debugging environment. The software development tool can also include a graphical interface that visually illustrates the configuration of the processor to assist the designer in configuring the processor. In one embodiment, the software development tool generates a synthesizable RTL description of the processor that can be used to fabricate the multi-processing system. In one embodiment, the software development tool generates a synthesizeable RTL description of a complete single or multi-processing system.

The software development tool configures various aspects of the processor architecture. For example, the software development tool can configure an instruction set of at least one of the plurality of computational units. The software development tool can also configure data paths to an input/output module. The software development tool can also configure the width of the data path of at least one of the plurality of computational units. The software development tool can also configure data routing paths of at least one of the plurality of computational units. The software development tool can also configure the task queue to include up to three queue modules for standard, high priority, and interrupt task queue functionality and also to define the depth of each queue. The software development tool can also configure the plurality of memory interface units.

In addition, the software development tool can configure various operating parameters of the processor. For example, the software development tool can configure an instruction execution speed of at least one of the plurality of computational units. The software development tool can also configure the energy that is required to operate at least one of the plurality of computational units.

The present invention also features a designer configurable multi-processor system. The system includes a plurality of designer configurable processors or task engines. In one embodiment, at least one of the plurality of processors comprises a Very Long Instruction Word (VLIW) processor. Each of the processors includes a plurality of designer configurable computational units that operate in parallel.

The multi-processor system also includes a memory device that communicates with the plurality of computational units of the processor task engines through a data communication module. The memory device stores at least one of data and instruction code for the computational units.

The multi-processor system also includes an input/output (I/O) module that communicates with at least one of the plurality of processor task engines through an I/O interface unit, such as an Internal Bus Interface Unit (IBIU) or External Bus Interface Unit (EBIU). The software development tool can also configure the I/O module features including, but not limited, to size and type of control registers, interrupt mechanisms, wait state functionality, arbitration functionality, and size and type of memory.

The multi-processor system also includes a software development tool that configures the multi-processor system. The software development tools can include at least one of a compiler, an assembler, an instruction set simulator, or a debugging environment. The software development tool can also include a graphical interface that visually illustrates the configuration of the processor to assist the designer in configuring the processor. In one embodiment, the software development tool generates a synthesizable RTL description of the plurality of processors or of the multi-processor system that can be used to fabricate the multi-processing system.

The software development tool configures various aspects of the multi-processor system and the processor architecture. For example, the software development tool can configure an instruction set of at least one of the plurality of computational units. The software development tool can also configure data paths and data path widths to and from an input/output module. The software development tool can also configure the width of the data path of at least one of the plurality of computational units. The software development tool can also configure data routing paths of at least one of the plurality of computational units.

In addition, the software development tool can configure various operating parameters of the plurality of processors and of the multi-processor system. For example, the software development tool can configure an instruction execution speed of at least one of the plurality of computational units in a processor. The software development tool can also configure the energy that is required to operate at least one of the plurality of computational units in a processor.

The present invention also features a method of defining a computational unit for multiprocessor hardware system. The method includes defining at least one of the architecture and the operating parameters of at least one computation unit in a Very Long Instruction Word (VLIW) processor with a software development tool.

The architecture can include the instruction set of the at least one computation unit. The architecture can also include the data path width of the at least one computation unit. In addition, the architecture can include the internal data routing path of the at least one computation unit. The operating parameters can include the instruction speed of the at least one computation unit. The operating parameters can also include the energy used to operate the at least one computation unit with the software development tool.

The method also includes generating data from the software development tool that integrates the computation units, memory interface units, task queue, and I/O modules into the VLIW processor task engine. In one embodiment, scripts are generated for electronic design automation tools. In one embodiment, the method also includes performing a consistency check to validate the multi-processor hardware system.

### BRIEF DESCRIPTION OF THE DRAWINGS

This invention is described with particularity in the appended claims. The above and further advantages of this invention can be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a block diagram of a configurable VLIW processor task engine of the present invention.

FIG. 2 illustrates a block diagram of one embodiment of a task queue for the configurable VLIW processor task engine of the present invention.

FIG. 3 illustrates a block diagram of one embodiment of a task controller unit for the configurable VLIW processor task engine of the present invention.

FIG. 4 illustrates a block diagram of one embodiment of a memory interface unit for the configurable VLIW processor task engine of the present invention.

FIG. 5 illustrates a block diagram of one embodiment of a computation unit for the configurable VLIW processor task engine of the present invention.

FIGS. 6a through 6c illustrate block diagrams of programmable multi-processor system architectures that include a plurality of VLIW processor task engines according to the present invention.

FIG. 7 illustrates a block diagram of one embodiment of software tools according to the present invention that configure a multi-processor system architecture including VLIW processor task engine of the present invention.

FIG. 8 illustrates a block diagram of one embodiment of the implementation kit that generates a hardware description of the VLIW processor task engines and the multi-processor system that are used to fabricate the chip.

### DETAILED DESCRIPTION

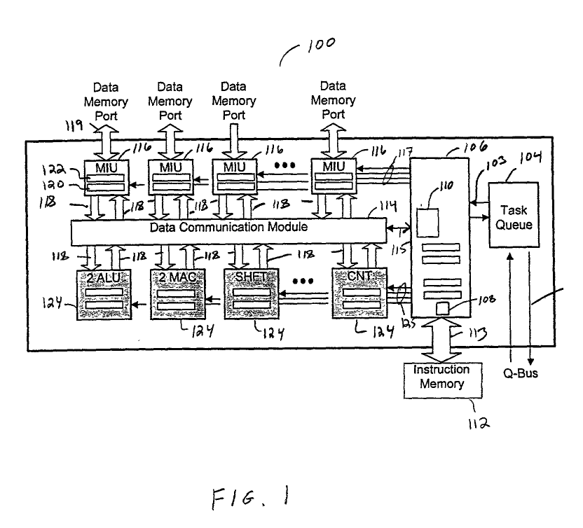

FIG. 1 illustrates a block diagram of a configurable VLIW processor task engine 100 of the present invention. The processor or task engine 100 can be used in a single or a multiprocessor system. The processor task engine 100 communicates with the system through a task queue bus (Q-Bus) 102. The Q-bus 102 is a global bus for communicating on-chip task and control information between the processor task engines. The task engine 100 includes a task queue 104 that communicates with the task queue bus 102. The task queue 104 includes a stack, such as a FIFO stack, that stores tasks. The processor task engine executes its task list in FIFO order.

The processor task engine 100 also includes a task control unit 106 that communicates with the task queue 104 through a task controller bus 103. The task control unit 106 includes an instruction decoder 108 that decompresses and decodes the instructions stored in an instruction memory so that they can be understood and executed by the task engine 100. The task control unit 106 also includes a branch control unit 110 that controls the order of executing instructions in the processor task engine 110.

The processor task engine 100 also includes an instruction memory 112. The instruction memory 112 is in communication with the task control unit 106 through a memory bus 113. The instruction memory 112 stores any type of instructions. The instruction memory 112 can be shared memory or private memory. The instruction decoder 108 in the task control unit 106 determines the desired memory address.

The processor task engine 100 also includes a data communication module 114 that routes data in the task engine 100. In one embodiment, the data communication module 114 includes an array of bus multiplexers that performs the function of a crossbar switch. The data communication module 114 communicates with the task control unit 106 through a data communication control bus 115. Instructions and task control information from the task control unit 106 are transmitted directly to the data communication module 114. The branch controller module 110 receives control information from the data communication module 114 and causes the task control unit 106 to change the task schedule.

The processor task engine 100 also includes at least one memory interface unit 116. In one embodiment, the processor task engine 100 includes a plurality of memory interface units 116. The memory interface units 116 communicate with the task control unit 106 through a memory interface unit control bus 117. The memory interface units 116 include one or more read or write memory ports 118 that communicate the data communication module 114. The memory interface units 116 also include a data memory port bus 119 that communicates with data memories. Each of the memory interface unit 116 has an address generation unit 120 and one or more local registers 122 for storing data and address information.

The processor task engine 100 includes at least one logic or computational unit 124 that is in communication with the data communication module 114. The task control unit 106 communicates with the computational units 124 through a computational unit control bus 125. The computational unit 124 can be a designer configurable custom logical or computational unit. For example, the computational unit 124 can be any type of computation unit such as an ALU, multiplier, or shifter. In one embodiment, the processor task engine 100 includes a plurality of computation units 124. Multiple read or write memory ports 118 can be attached to each of the computation units 124.

Designers can define the number and type of operations that can be executed for each instruction of each computation unit 124. For example, to implement ALU intensive application domains, a designer can create a task engine with three ALUs, one shifter and one MAC. To implement MAC-intensive and balanced application domains, a designer can also create a processor with two ALUs, two shifters and two MACs.

In one embodiment, the data communication module 114 is a register-routed module that manages routing of data from register-to-register. The data communication module 114 routes data from result or data memory registers to input registers of the computational units 124. The data communication module 114 also routes data from result registers of computational units 124 to result or data memory registers. One feature of the present invention is that the designer can configure the data communication module 114 to define a collection of parallel data path elements (such as ALUs, MACs, etc.) in the task engine 100.

The VLIW processor task engine 100 of the present invention is a highly configurable processor. The designer can use software tools to add custom logic and computation units into the data paths that implement the specific functionality of a target application. These custom logic and computation units significantly improve performance of the processor. Thus, one advantage of the VLIW task engine of the present invention is that the overall system performance can be increased by creating different combinations of computation and logic units within the processor that are designed for specific applications. This avoids the necessity of adding custom logic and instructions.

The designer can also use software tools to add custom data paths, which also can significantly improve performance of the processor. Thus, another advantage of the VLIW task engine of the present invention is that the task engine 100 does not aggregate the computation units 126 into a single data path. The designer can add custom data paths, which optimize the performance of the computation unit 124 for each instruction. The designer can also define a collection of parallel data path elements (ALUs, MACs, etc.) in the task engine 100.

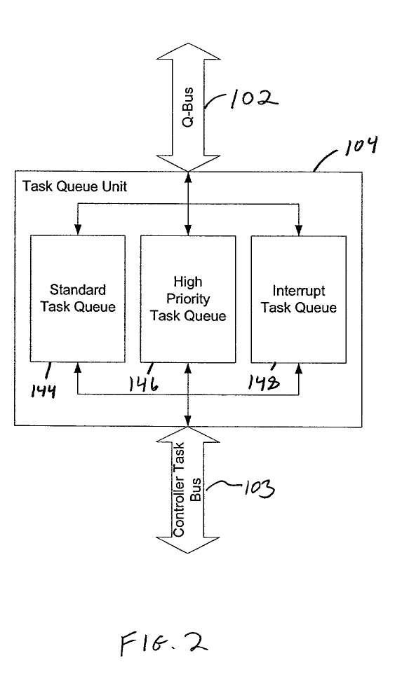

FIG. 2 illustrates a block diagram of one embodiment of a block diagram of a task queue 104 for the configurable VLIW processor task engine 100 of the present invention. The processor task engine 100 communicates with the system through the Q-bus 102. The Q-bus is coupled to the task queue 104. The task queue 104 communicates with the task control unit 106 through the task controller bus 103. Control information is communicated from the task queue 104 to the computational or logic units 124 of the VLIW processor task engine 100.

The task queue 104 includes a standard task queue 144 that, in one embodiment is a stack, such as a FIFO stack, that stores tasks received from the task queue bus 102. The task queue 104 also includes a high priority task queue 146 that stores priority tasks received from the task queue bus 102. In addition, the task queue 104 includes an interrupt task queue 148 that stores interrupt tasks. Numerous other embodiments of the task queue 104 can be used with the processor task engine 100 of the present invention.

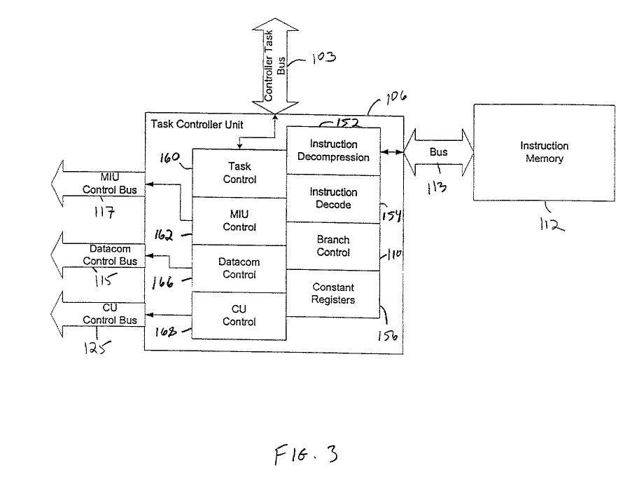

FIG. 3 illustrates a block diagram of one embodiment of a task controller unit 106 for the configurable VLIW processor task engine 100 of the present invention. The task controller unit 106 communicates with the instruction memory 112 through the memory bus 113. The task controller unit 106 includes an instruction decompression unit 152 that decompresses instructions received from the instruction memory that were compressed to reduce the number of bytes required to store the instructions.

An instruction decoder 154 decodes the decompressed instructions to generate instructions that can be executed by the computational or logic units 124. The branch control unit 110 controls the order of executing instructions in the processor task engine 110. The task controller unit 106 also includes constant registers.

The task controller unit 106 communicates with the task queue 104 through the task controller bus 103. The task controller unit 106 includes controlling circuitry 160 for managing the operation of the task controller unit 106. The task controller unit 106 also includes memory interface unit control circuitry 162 that is coupled to the memory interface unit control bus 117.

In addition, the task controller unit 106 includes data communication control circuitry 166 that is coupled to the data communication module 114 through a control bus 115. Furthermore, the task controller unit 106 includes computational unit control circuitry 168 that is coupled to the logical or computational units 124 through the computation unit control bus 125. Numerous other embodiments of the task controller unit 106 can be used with the processor task engine 100 of the present invention.

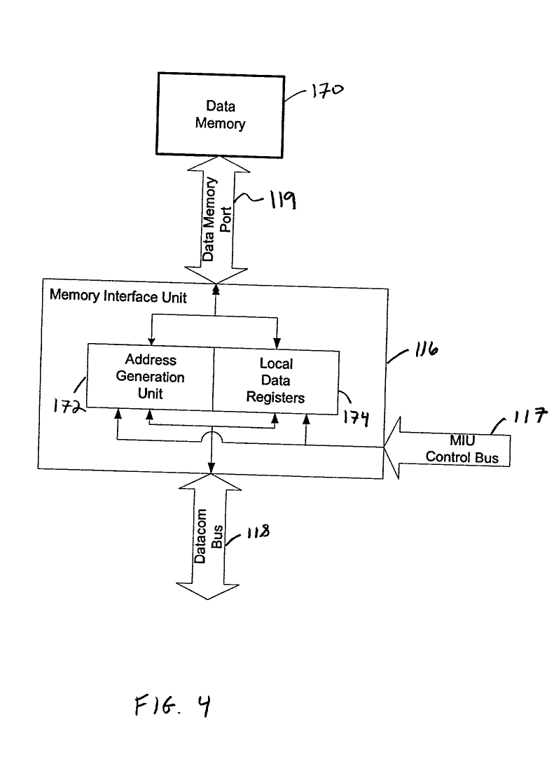

FIG. 4 illustrates a block diagram of one embodiment of a memory interface unit 116 for the configurable VLIW processor task engine 100 of the present invention. The memory interface unit 116 communicates with a data memory 170 through the data memory port bus 119. The memory interface unit 116 receives instructions from the task controller unit 106 through the memory interface unit control bus 117. The memory interface unit 116 communicates with the data communication module 114 through the data communication bus 118. The memory interface unit 116 includes an address generation unit 172. The memory interface unit 116 also includes local data registers 174 for storing data. Numerous other embodiments of the memory interface unit 116 can be used with the processor task engine 100 of the present invention.

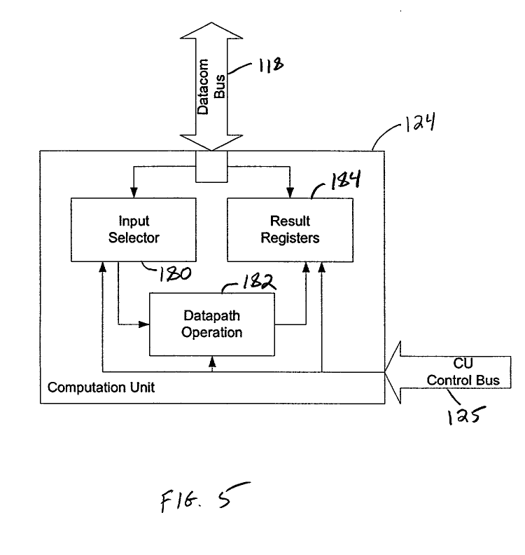

FIG. 5 illustrates a block diagram of one embodiment of a computation unit 124 for the configurable VLIW processor task engine 100 of the present invention. The task controller unit 106 sends task instructions to the computation unit 124 through the computation unit control bus 125. The instructions are routed to an input selector 180 and to a data path operation unit 182. The computation unit 124 communicates with the data communication module 114 through the data communication bus 118.

Data is transported to and from the data communication module 114 through the data communication bus 118. The data path operation unit 182 performs operations on the data and stores the results of the operation in result registers 184. Numerous other embodiments of the computation unit 124 can be used with the processor task engine 100 of the present invention.

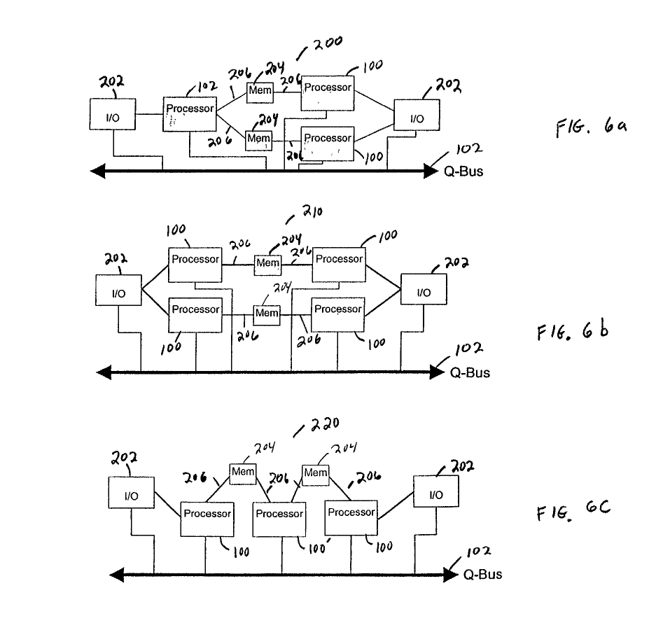

FIG. 6a through FIG. 6c illustrate embodiments of programmable multi-processor system architectures that include a plurality of VLIW processor task engines 100 according to the present invention. The multi-processor systems include system input/output interfaces. The multi-processor systems also include data memories that provide data communication between processor task engines. The architecture of the multi-processor system and the configuration and programming of the VLIW processor task engines 100 are chosen to perform application specific functions in the multi-processor system 200.

FIG. 6a illustrates one embodiment of a programmable multi-processor system architecture 200 that includes a plurality of VLIW processor task engines 100 according to the present invention. The multi-processor system 200 includes three VLIW processor task engines 100. Each of the processor task engines 100 is coupled to the Q-bus 102 as described in connection with FIG. 1.

The multi-processor system architecture 200 also includes two I/O units 202. The I/O units 202 interface with external devices and input data to the multi-processor system 200 and that output resulting or computed data. The I/O units 202 are coupled to the Q-bus and to at least one of the VLIW processor task engines 100. In the embodiment shown in FIG. 6a, two of the processor task engines 100 share one of the I/O units 202. One advantage of the multi-processor system architecture 200 is that the processors task engines 100 and the I/O units 202 are attached to a single global bus (Q-bus 102) that communicates on-chip task and control information between the processor task engines 100 and that inputs instructions and inputs and outputs data.

The multi-processor system architecture 200 also includes two data memories 204 that facilitate data communication between the VLIW processor task engines 100. The processor task engines 100 communicate with the data memories 204 through a data bus 206. In one embodiment, the data memories 204 are on-chip data memories. In one embodiment, the data memories 204 are shared memories that are shared between two or more processor task engines 100. In other embodiment, the data memories 204 are private data memories that are private to particular task engines 100. In the embodiment shown in FIG. 6a, each of the two data memories 204 is shared by two of the processors task engines 100.

The multi-processor system architecture 200 also includes instruction memories (not shown) that communicate with the VLIW processor task engines 100. The instruction memories interface with the task controller module 106 of the task engine 100 as described in connection with FIG. 1. In one embodiment, the instruction memories are shared memories that are shared between two or more processor task engines 100. In other embodiment, the instruction memories are private data memories that are private to particular task engines 100.

FIG. 6b illustrates another embodiment of a programmable multi-processor system architecture 210 that includes a plurality of VLIW processor task engines 100 according to the present invention. The multi-processor system architecture 210 includes four processor task engines 100. Each of the processor task engines 100 is coupled to the Q-bus 102. The multiprocessor system architecture 210 also includes two I/O units 202 that input data to the multiprocessor system 210 and that output resulting or computed data. The I/O units 202 are coupled to the Q-bus and coupled to two of the VLIW processor task engines 100. The multi-processor system architecture 210 also includes two data memories 204 that facilitate data communication between the processors. The VLIW processor task engines 100 communicate with the data memories 204 through the data bus 206. Each of the two data memories 204 is shared by two of the processors task engines 100.

FIG. 6c illustrates another embodiment of a programmable multi-processor system architecture 210 that includes a plurality of VLIW processor task engines 100 according to the present invention. The multi-processor system architecture 210 includes three processor task engines 100. Each of the processor task engines 100 is coupled to the Q-bus 102. The multiprocessor system architecture 210 also includes two I/O units 202 that input data to the multiprocessor system 210 and that output resulting or computed data. The I/O units 202 are coupled to the Q-bus and coupled to one of the VLIW processor task engines 100.

The multi-processor system architecture 210 also includes two data memories 204 that facilitate data communication between the processors. One of the VLIW processor task engines 100′ is not directly coupled to an I/O unit 202 and can input and output data only though the data memories 204. The VLIW processor task engines 100 communicate with the data memories 204 through the data bus 206. Each of the two data memories 204 is shared by two of the processors task engines 100. There are numerous other embodiments of multi-processor system architectures that include a plurality of VLIW processor task engines 100 according to the present invention.

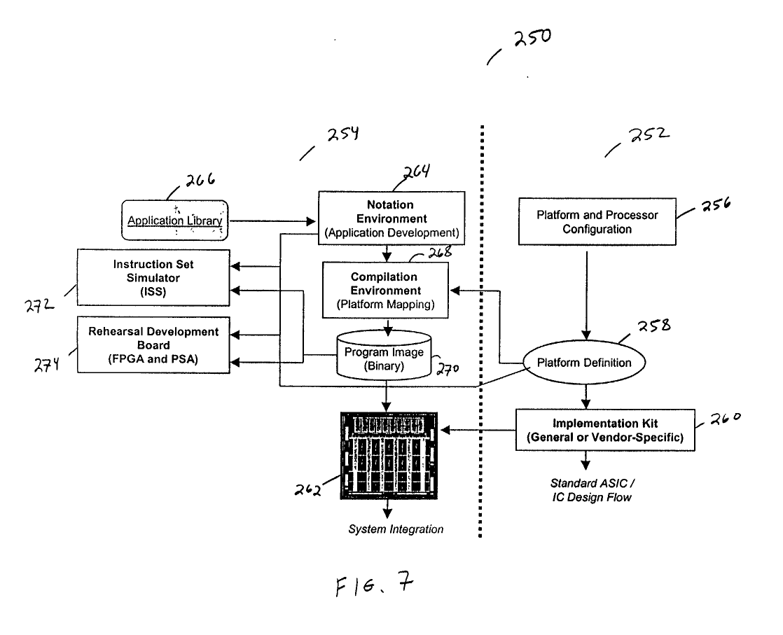

FIG. 7 illustrates a block diagram of one embodiment of software tools 250 according to the present invention that configure a multi-processor system architecture including VLIW processor task engine 100 of the present invention. Software tools according to the present invention can include any type of software tool, such as a software compiler, an assembler, a processor instruction set simulator, or a software debug environment.

The software tools 250 include a designer interface that can have an intuitive drag-and-drop facility to arrange various software objects. In one embodiment, the software tools 250 have high-level language programmability. High-level language programmability reduces the time-to-market. Also, high-level language programmability is advantageous for configuring VLIW processor task engines because of the complexity of managing parallel data path elements, multiple memory accesses and distributed register systems. Generally, the software tools 250 include hardware definition tools 252 and software development tools 254.

The hardware definition tools 252 include platform and processor configuration software 256. The designer inputs a relatively simple description of the multi-processor hardware architecture, task engines, and logic units into the platform and processor configuration software 256. The designer can define the type and number of VLIW processor task engines, shared data memories, and the number and type of I/O modules that implements the designer's target application. In one embodiment, the descriptions of the multi-processor hardware architecture, task engines, and logic units are written in Verilog, which is supported by a pre-processor for controlled generation. The Verilog files are added into the system and are used to generate complete processors and multi-processor structures.

The hardware definition tools 252 include platform definition software 258. The platform definition software 258 receives code generated by the platform and processor configuration software 256. The platform definition software 258 generates code for an implementation kit that implements the multi-processor system architecture in an application specific integrated circuit. The platform definition software 258 also generates code for the software development tools 254 that is used for application development and compilation.

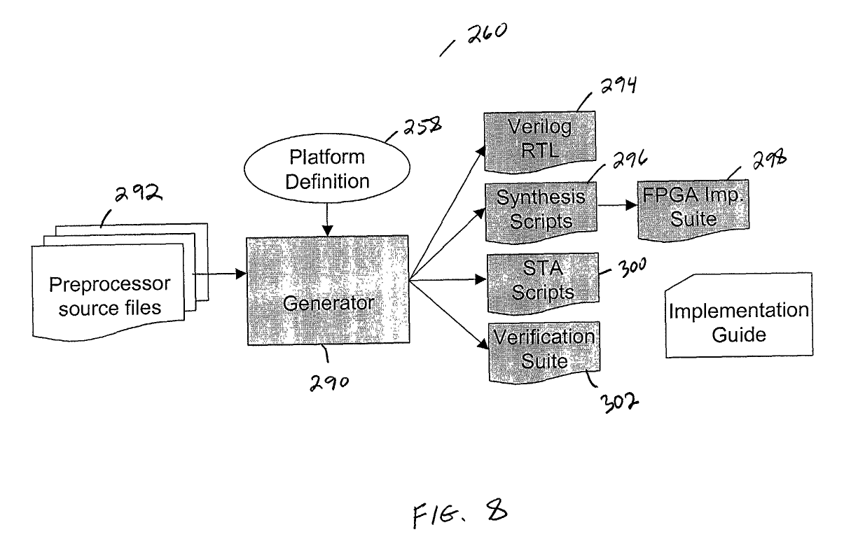

The hardware definition tools 252 also include an implementation kit 260. The implementation kit 260 generates the code required to implement a designer-defined multiprocessor system architecture that includes VLIW processor task engines 100 of the present invention in a chip 262. In one embodiment, the code generated by the implementation kit 260 is general code that can be implemented with industry standard Application Specific Integrated Circuits (ASICs). In other embodiments, the code generated by the implementation kit 260 is specific to particular ASIC vendors. The implementation kit 260 is described in more detail in connection with FIG. 8.

The software development tools 254 include a notation or application development environment 264. The application development environment 264 receives the code generated by the platform definition software 258. An application library 266 that includes predefined code for specific applications can be available to the application development environment 264. Using predefined code for specific applications generally reduces the time-to-market.

The software development tools 254 include a compilation environment or compiler 268. Other embodiments of the software development tools 254 include an assembler. The compiler 268 receives code generated by the platform definition software 258 and by the application development environment 264 and compiles the code to generate a binary program image 270 of a hardware description.

The compiler 268 generates a specific, synthesizeable hardware description of the multiprocessor hardware system including VLIW processor task engines 100 having designer-defined computation units 124. One advantage of the compiler of the present invention is that the description of the multi-processor system can be technology independent and can be synthesized and optimized to various technologies as required by the designer. Also, the necessary tool scripts and database can be made available to the designer.

Specifically, the compiler 268 maps operations for a particular application described in the code generated by the application development software 264 onto a VLIW processor task engines 100 by matching each desired operation to a computation unit 124 that supports the desired operation. The compiler 268 performs parallelization of operations and resource management. The compiler 268 generates VLIW code that manages data movement through concurrent data paths.

Another advantage of the compiler of the present invention is that it decouples the definition of operations that can be implemented by processor task engines 100 from the definition of the computation units 124 contained in the task engine 100. This flexibility provides significant freedom for the compiler 268 to create optimal mappings of application software onto particular computation units 124. Thus, an advantage of the VLIW processor task engines 100 of the present invention is that they offer the programmability benefits of prior art general-purpose processors and the performance benefits of custom logic.

The compiler 268 also configures the specific features of the VLIW processor task engines 100. For example, the compiler 268 can define one or more of the width of the task engine data path, the number and types of computational units 124, the internal data routing in the data communication module 114, the structure and depth of the task queue 104, the structure of the task controller module 106, and the number and types of memory units directly accessed by the processor 100. In addition, the compiler 268 configures the operational characteristics of the task engines 100 including instruction execution speed, computational efficiency, and the amount of energy required to power the task engine 100.

The compiler 268 can also define the number of slots available in the instruction word. In addition, the compiler 268 can allocate instruction slots to the various computational units 124. These features allow the designer to populate the task engines 100 with a diverse mix of computation units 124, while still maintaining a relatively small instruction word. These features also allow the designer to configure a RISC-like task engine by overlaying multiple computation units 124 into a single slot in the instruction word.

Furthermore, the compiler 268 defines the characteristics of the VLIW instructions used by the task engines 100. A designer can use the compiler 268 to reduce the instruction space. In addition, a designer can define how operations in computational units 124 overlap during instruction cycles. Therefore, another advantage of the VLIW processor task engines 100 of the present invention is that a designer can use software tools to configure numerous features of the task engine 100 for a specific application.

The compiler 268 can intelligently select the optimal computational units 124 for specific operations. In one embodiment, operations are implemented as Java methods with embedded directives describing the op-code pneumonic that maps the operation to a computation unit 124. This separates the definition of operations from the definition of computation units. During compilation, the compiler 268 selects the specific computation unit 124 that will execute the operation. Thus, another advantage of the multi-processor system of the present invention is that operations are not limited to execute on a specific computation units 124.

The ability to intelligently select the optimal computational units 124 for specific operations is important for some applications. For example, in applications that can be accelerated by adding an operation to perform a particular function, such as a 5-bit addition, the designer could create a custom computational unit to perform this function and add it into the processor. The operation and additional logic can also be added to a pre-defined ALU computation unit. The pre-defined ALU computational unit has a number of operations that it supports already and the designer simply maps those operations plus the new function, such as a 5-bit addition operation, to the new computation unit.

In one embodiment, the compiler 268 generates the necessary tool scripts for support of numerous Electronic Design Automation (EDA) tools used in the art for design and verification of integrated circuits. The compiler can generate the necessary tool scripts for an instruction set simulator 272. In addition the compiler can generate the necessary tool scripts for a rehearsal development board 274 that tests the design.

The software development tools 254 can include verification tools that check the definition of the VLIW processor task engine 100 configuration. The verification tools include one or more programs that perform at least one consistency test to validate the configuration. The software development tools 254 can also include a hardware estimator that estimate operational parameters, such as clock rate, die size, gate count, and power requirements for the resulting hardware implementation of the VLIW processor task engine 100. The software development tools 254 can also generate configuration files that are necessary to enable the embedded software development tools to map application programs to the VLIW processor task engine 100.

FIG. 8 illustrates a block diagram of one embodiment of the implementation kit 260 that generates a hardware description of the VLIW processor task engines and the multi-processor system. The implementation kit 260 generates the code required to implement a designer-defined multi-processor system architecture that includes VLIW processor task engines 100 of the present invention in a chip 262.

An implementation code generator 290 receives code generated by the platform definition software 258 and source files from one or more preprocessors 292. The implementation code generator 290 generates various hardware description codes. In one embodiment, the implementation code generator 290 generates a synthesizeable RTL hardware description 294, such as Verilog RTL code. In one embodiment, the implementation code generator 290 generates synthesis scripts 296. A development board implementation suite 298 uses the synthesis scripts 296 to generate a rehearsal processor, such as a FPGA, or other type of programmable gate array, in the development board 274.

In one embodiment, the implementation code generator 290 generates static timing analysis scripts 300. The implementation code generator 290 can also generate verification code 302 that is used to perform consistency tests to validate the configuration.

The designer configurable task engines and the multi-processor systems of the present invention are well suited for System on Chip (SoC) architectures an have numerous advantages over prior art custom integrated circuits. The designer configurable task engines offer high-performance with a high degree of programmability. These task engines and systems providing a high-level of parallelism and the ability to define custom data path elements. These features eliminate the need for custom logic blocks, which reduces the total cost of the system and increases the time to market.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims. For example, although specific embodiments were described for the task queue, task control unit, memory interface unit, and computational unit, numerous other embodiments of these devices can be used with the processor task engine of the present invention.

What is claimed is:

1. A designer configurable processor comprising:
a. a plurality of designer configurable computational units operating in parallel;
b. a memory device that communicates with the plurality of computational units through a data communication module; and
c. a software development tool that configures the plurality of computational units and a data path though the data communication module.

2. The processor of claim 1 wherein the designer configurable processor comprises a Very Long Instruction Word (VLIW) processor task engine.

3. The processor of claim 1 wherein the data communication module comprises a register routed data communication module.

4. The processor of claim 1 wherein the memory device stores at least one of data and instruction code.

5. The processor of claim 1 further comprising a task queue that communicates with the data communication module, the task queue scheduling tasks for the processor.

6. The processor of claim 5 wherein the task queue comprises a task queue controller module that communicates with the data communication module and a task queue module that communicates with task queue bus.

7. The processor of claim 6 further comprising an instruction memory that communicates with the task queue controller module, the instruction memory storing tasks for the processor.

8. The processor of claim 1 wherein the software development tool comprise at least one of a compiler, an assembler, an instruction set simulator, or a debugging environment.

9. The processor of claim 1 wherein the software development tool comprises a graphical interface that visually illustrates the configuration of the processor.

10. The processor of claim 1 wherein the software development tool generate a synthesizable RTL description of the processor.

11. The processor of claim 1 wherein the software development tool configures a data path from the processor to an input/output module.

12. The processor of claim 11 wherein the software development tool configures a width of the data path from the processor to the input/output module.

13. The processor of claim 1 wherein the software development tool configures a data routing path of at least one of the plurality of computational units.

14. The processor of claim 1 wherein the software development tool configures an instruction execution speed of at least one of the plurality of computational units.

15. The processor of claim 1 wherein the software development tool configures an energy required to operate at least one of the plurality of computational units.

16. The processor of claim 1 wherein the software development tool configures an instruction set of at least one of the plurality of computational units.

17. The multi-processor system of claim 1 wherein at least one of the plurality of designer configurable computational units comprises a set of input registers and a set of result registers.

18. A designer configurable multi-processor system comprising:
a. a plurality of designer configurable processors, each of the plurality of processors comprising a plurality of designer configurable computational units operating in parallel;
b. a memory device that communicates with the plurality of computational units through a data communication module;
c. an input/output (I/O) module that communicates with at least one of the plurality of processors through an I/O bus; and
d. a software development tool that configures the multi-processor system.

19. The multi-processor system of claim 18 wherein at least one of the plurality of plurality of processors comprises a Very Long Instruction Word (VLIW) processor.

20. The multi-processor system of claim 18 further comprising an instruction memory device that communicates with at least one of the plurality of processors.

21. The multi-processor system of claim 18 wherein the software development tool generates a synthesizable RTL description of at least one of the plurality of processors.

22. The multi-processor system of claim 18 wherein the software development tool configures a data path to the I/O module.

23. The multi-processor system of claim 22 wherein the software development tool configures a width of the data path to the I/O module.

24. The multi-processor system of claim 18 wherein the software development tool configures a data routing path of at least one of the plurality of computational units.

25. The multi-processor system of claim 18 wherein the software development tool configures an instruction execution speed of at least one of the plurality of computational units.

26. The multi-processor system of claim 18 wherein the software development tool configures an energy required to operate at least one of the plurality of computational units.

27. The processor of claim 18 wherein the software development tool configures an instruction set of at least one of the plurality of computational units.

28. A method of defining a computational unit for a multi-processor hardware system, the method comprising:
a. defining an architecture of at least computation unit in a Very Long Instruction Word (VLIW) processor with a software development tool; and
b. generating data from the software development tool that integrates the at least one computation unit into the VLIW processor task engine.

29. The method of claim 28 further comprising defining a data path width of the at least one computation unit with the software development tool.

30. The method of claim 28 further comprising defining an internal data routing path of the at least one computation unit with the software development tool.

31. The method of claim 28 further comprising defining an energy used to operate the at least one computation unit with the software development tool.

32. The method of claim 28 further comprising defining an instruction speed of the at least one computation unit with the software development tool.

33. The method of claim 28 further comprising defining an instruction set of the at least one computation unit with the software development tool.

34. The method of claim 28 further comprising performing a consistency check to validate the multi-processor hardware system.

35. The method of claim 28 wherein the generating data from the software development tool comprises generating scripts for an electronic design automation tool.
